(19) United States
(12) Patent Application Publication
(10) Pub. No.: US 2007/0102262 A1
(43) Pub. Date: May 10, 2007

(54) Continuous motion article diverting system

(75) Inventor: Russell Varone, Red Lion, PA (US)

Correspondence Address: VENABLE LLP, P.O. BOX 34385, WASHINGTON, DC, 20043-9998, US

(73) Assignee: Graham Packaging Company, L.P., York, PA (US)

(21) Appl. No.: 11/593,644

(22) Filed: Nov. 7, 2006

Related U.S. Application Data
(60) Provisional application No. 60/733,792, filed on Nov. 7, 2005.

(51) Int. Cl. B65G 47/68

(52) U.S. Cl. 198/436

(57) ABSTRACT

An apparatus for positioning conveyed articles at different lengths from an initial position includes an endless loop transport system that moves a number of articles in a direction of transport and guide rails attached to the transport system, which extend approximately perpendicular to the direction of transport. A holding device is movably disposed on a respective guide rail and a controller causes the holding device to move perpendicular to the direction of transport along the respective guide rail. Articles are gripped by the holding device while moving in continuous motion at an initial position and then moved to different lengths along the guide rails via the controller.

### BACKGROUND OF THE INVENTION

1. Field of the Invention

The present invention relates to a system for moving conveyable articles to varying positions away from the initial position while the articles are being conveyed at high speeds. More particularly, the invention relates to a system for moving articles, such as containers, approximately perpendicular from a continuous path to varying positions away from the initial position while the articles are being moved at high speeds.

2. Related Art

Certain steps in the manufacturing of plastic containers require a means for transporting containers between processes, machines or locations. Examples of transport methods include: bulk conveying of randomly oriented containers by conveyor belt; bulk conveying of randomly oriented container by pneumatic/vacuum transport tubes; single file conveying of deliberately oriented containers by conveyor belt; and single file conveying of deliberately oriented containers by air-driven or rail guided conveyor. These methods are used in a broad range of industries at speeds varying from a few containers per minute to over 2,000 containers per minute. Thus, the increased line speeds requires more complex control systems that require more highly skilled technicians to service and maintain.

While the above transport methods and associated means for conveyance are suitable for many applications, they share a common weakness in that the containers conveyed in bulk or in single file are not easily divided into multiple streams with any level of accuracy or control. In the container industry, there is a need to divide a single row of containers into multiple parallel rows while the containers are being transported from one conveyance to a plurality of conveyances. Known means to accomplish this goal can be found in U.S. Pat. No. 5,441,142 to Schneider (diverter blade); U.S. Pat. No. 4,723,649 to Hartness et al. (pivoting guide chute); U.S. Pat. No. 6,772,872 to Spangenberg et al. (selectively movable guide channel); U.S. Pat. No. 6,715,600 to Ronchi (deviating arm); U.S. Pat. No. 5,944,165 to Mannlein et al. (rocker plate and rocker arms); U.S. Pat. No. 5,115,902 to Snyder et al. (lane divider system); U.S. Pat. No. 4,941,561 to Yamabe et al. (endless chain sorting device with slidable conveying boards); U.S. Pat. No. 4,830,173 to Hartness et al. (pivotally mounted chute); and U.S. Pat. No. 4,817,779 to Beck et al (pivoting guide track).

One of the know deficiencies of conventional gating/divider systems is the difficulty in repeatedly, accurately and reliably performing the dividing operation. Many of the devices discussed above fail to precisely control the position and orientation of the container during transfer from a single row to a row of multiple parallel rows. Proper container handling in any conveyance/divider system is dependent upon multiple variables including container weight, center of gravity, material of construction, line speed and control systems. Long term trends in the container industry have decreased container weights, which tends to raise the center of gravity, thereby resulting in containers that are more difficult to control during conveyance. In addition, the change of materials has made containers more difficult to handle than those that stand stable during conveying. Consequently, the prior art lacks positional control and precision for dividing containers thereby allowing containers to fall, tilt, jam or otherwise interrupt the flow of the dividing process.

Other prior art solutions require the containers in motion to be stopped while the pivoting guide chute, selectively movable guide channel, or other diverting blade transitions from one delivery point to another delivery point. Stopping containers in motion on a conveyor creates potential for disruptions and jams. In addition, large lengths of conveyance placed upstream and downstream of the gating/divider system are required so that there is sufficient space for the containers to accumulate while waiting for the gating/divider device to transition from one point to another point. Complex control routines that route the containers in a different direction are also used in combination with the large lengths of conveyance so that the containers are circulated while the gating/divider system is transitioning. Complex control routines and large lengths of conveyance require large capital outlays, as well as large areas of floor space to accommodate the need to stop containers while the gating/divider device is transitioning.

### SUMMARY OF THE INVENTION

Applicants overcome shortcomings in the prior art with their inventive system, which allows articles to be separated into multiple positions while in continuous motion. In addition, the inventive system operates with a high level of precision and control over the position of the article at extremely high speeds.

For example, this can be achieved with an apparatus for positioning conveyed articles, such as containers at different lengths from an initial or loading position according to an embodiment of the invention. In a preferred embodiment, the apparatus would position containers in a direction parallel to the axis of travel. The inventive conveying and positioning apparatus includes an endless loop transport system that moves a number of articles in a direction of transport; guide rails attached to the transport system and extending approximately perpendicular to the direction of transport; a holding device movably disposed on a respective guide rail; and a controller for moving the holding device perpendicular to the direction of transport along the respective guide rail where articles are gripped by a holding device while in continuous motion at an initial position and moved to different lengths along the guide rails.

In one embodiment, the inventive continuous conveying and positioning apparatus may employ an endless loop transport system including at least two starwheels spaced from one another and a segmented conveyor moving around the at least two starwheels. The endless transport system of this embodiment may move the articles, such as containers in a substantially horizontal plane with respect to the segmented conveyor.

In another embodiment, the endless loop transport system includes first and second segmented conveyors spaced from one another and moving together in the direction of transport, at least two sets of rotary starwheels spaced from one another along a spindle with the first and second segmented conveyors surrounding the at least two rotary starwheels. The endless transport of this embodiment may have one set of starwheels and spindle positioned above the other set of starwheels and spindle so that the transport system moves in a substantially vertical manner, and wherein the gripped articles extend outwardly from the respective guide rail so that the sides and bottom of the article are exposed and can be visually checked manually or with an automated system (such as a camera).

The positioning and conveying apparatus according to the invention is relatively simple, compact and enables precise positioning of articles being conveyed by positively controlling the articles with the holding device. The positive control allows for higher speeds and more efficient operation. As a result, overall system lifetime purchase and operating costs will be much lower than conventional gating/divider systems. The positioning and conveying apparatus according to the invention can be directly linked to other machines or conveyors with no intermediate conveyors.

Precise, positive control of the articles is achieved with the positioning and conveying apparatus of the invention. One embodiment of the invention employs a holding device with one of a gripper, suction cup, spindle or chuck to hold the articles. A combination of rotary conveyors, mechanical gripping devices and a control system enables the positioning and conveying apparatus of the invention to be more dependable and robust than conventional gating/divider systems, which rely on forces such as gravity, air pressure and inertia for positioning, control and handling of articles.

As a result of the inventive positioning and conveying apparatus, more precise controls over positioning of articles is achieved with a simpler control system. In addition, the precise control allows for robust components that have the ability to operate at higher speeds and at lower costs than conventional systems.

The positioning and conveying apparatus according to the invention does not need lengthy conveyance runs, as the articles continue to move when being gripped by the holding device. Consequently, a smaller foot print and relative costs are obtained with the inventive system over conventional gating/divider systems.

In another embodiment according to the invention, a positioning and conveying apparatus for containers would be able to positively interface with an existing bottle blowing and testing equipment without releasing the container from the positive control of the holding device.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 illustrates an apparatus for positioning and conveying containers according to one embodiment of the invention;

FIG. 2 shows a planar view of the system using the apparatus of FIG. 1;

FIG. 3 illustrates the linking of the apparatus of FIG. 1 with other container processing machines;

FIG. 4 illustrates an apparatus for positioning and conveying containers according to a second embodiment of the invention;

FIG. 5 shows another view of the apparatus of FIG. 4;

FIG. 6 shows another embodiment of the positioning and conveying apparatus receiving a series of parallel streams of articles and positioning the articles into a single stream; and

FIGS. 7 and 8 show other view of the embodiment of FIG. 6.

### DETAILED DESCRIPTION OF THE INVENTION

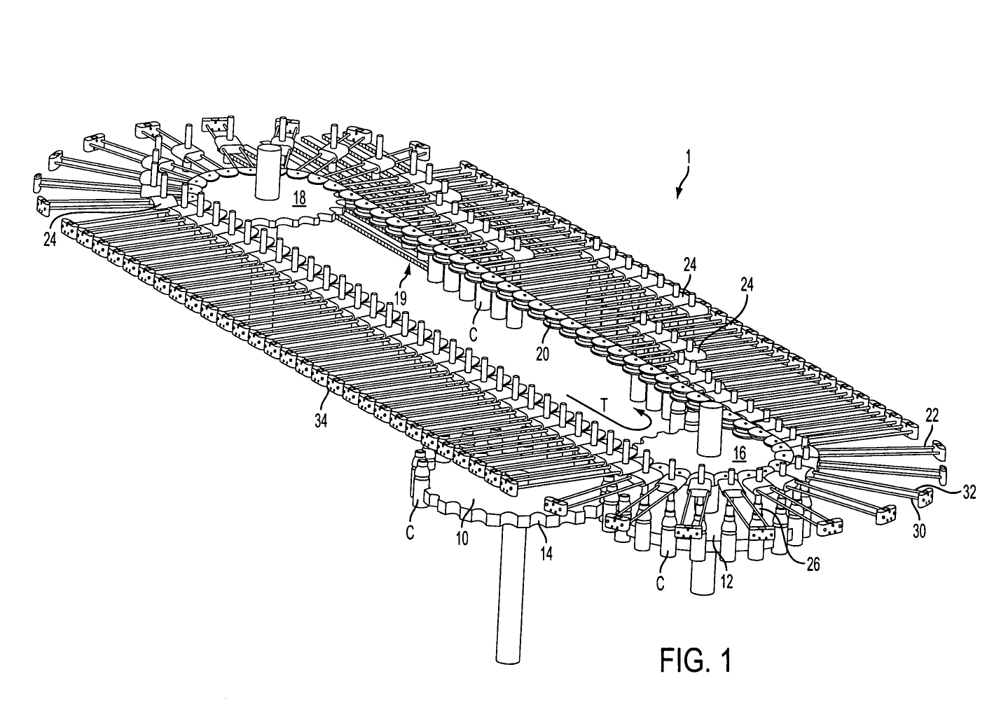

As shown in FIG. 1, a line of articles, such as containers C are introduced to an infeed station so that the containers C are fed single file to the apparatus 1 for positioning conveyed containers at different lengths from an initial position. One exemplary embodiment of a infeed station, as shown in FIG. 1 is a starwheel arrangement. Containers C are introduced to a first starwheel 10 and then moved to a second starwheel 12 of the apparatus 1. Starwheels 10 and 12 rotate about a respective axis and have grooves 14 spaced from one another for receiving a container C. The spacing of the grooves enables containers C to move in single line at a predetermined speed.

An endless loop transport system circles a third starwheel 16 disposed, in this exemplary embodiment, on the same axis as the second starwheel 12 and a fourth starwheel 18. It is envisioned that the third and second starwheel could be on different axes. The diameters of the third and fourth starwheels 16, 18 are smaller than the diameters of the first and second starwheels 10, 12. The endless loop transport system 19 may be a segmented conveyor such as a chain conveyor where each segment 20 corresponds to grooves 17 of the third and fourth starwheels 16, 18. The axes of starwheels 10, 12, 16 and 18 rotate at approximately the same speed so that containers C move into apparatus 1 in conjunction with the movement of endless loop transport system 19. Thus, a line of containers C are supplied by the first starwheel 10 in single file and are transferred to second starwheel 12 where the containers C enter the apparatus 1 for positioning conveyed containers at different lengths from an initial position. In the embodiment shown in FIG. 1, containers C may move along a table-top or a substantially horizontal plane, as the containers travel with the apparatus 1.

Each segment 20 of the endless loop transport system 19 has at least one guide rail 22 extending therefrom in a direction approximately perpendicular to the direction of transport T. The direction of transport T may be in the counter-clockwise or clockwise direction. A holding device 24 is movably disposed along the at least one guide rail 22. Holding device 24 includes a gripper 26 for holding the container C. Gripper 26 may grip the sides of the neck of the container, or be a suction cup, spindle or chuck that positively holds the container.

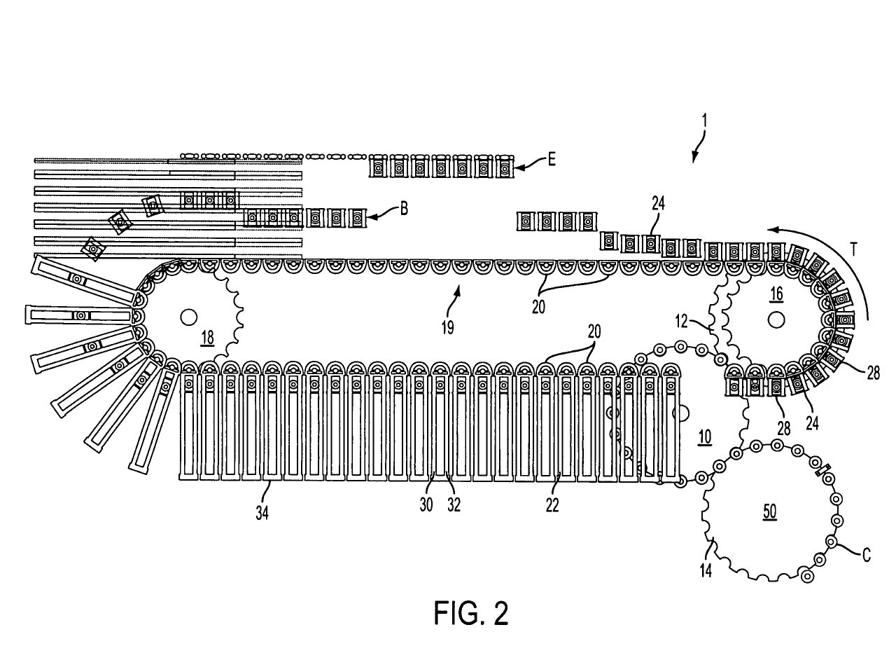

Looking at FIG. 2, containers C are loaded onto holding device 24 while the containers are conveyed by second starwheel 12 after being transferred from first starwheel 10. Initially, holding device 24 moves into alignment over the neck of a container C after the container C has rotated to the third groove position of starwheel 12. Then, the gripper 26 of holding device 24 secures container C over the next segment 28 of starwheel 12 while the container is moving along the transport system 19.

A guide rail 22 may include two rods 30, 32 separated by a distance. The holding device 24 moves along those rods bringing a gripped container C to a distance parallel to the direction of travel T. One end of the rods is segment 20 of the segmented conveyor and at the other end of the rods is a stop 34. Stop 34 serves two purposes: 1) holds the rods 30, 32 of the guide rail 22 in place and 2) does not allow holding device 24 to move beyond this point and thus serves as a end of the guide rail 22.

A controller 36, such as a computer, causes a pneumatic or mechanical diverter to move holding device 24 perpendicular to the direction of transport T along the respective guide rail 22 so that a gripped container C can be positioned at different lengths from the segmented conveyor while moving in continuous motion with the endless loop transport system. As shown in FIGS. 1 and 2, containers C can be positioned at a first position next to the segmented conveyor to enter a first delivery lane, a second position B spaced from the segmented conveyor so that the containers C are lined up to enter a second delivery lane up to a fifth position E to line up with a fifth delivery lane. While 5 delivery lanes are shown in this exemplary embodiment, the guide rail 22 can have varying lengths depending upon the amount of delivery lanes desired or other processing lanes desired.

Holding device 24 grips a container C at segment 28 of starwheel 12 and then the controller 36 begins to orient containers C after they pass starwheel 12. A positioning control enables (or causes) holding device 24 to move along guide rails 22 to an exact position so that the gripped container is moved to a desired transition point (e.g., aligned with a delivery lane). The positioning control may be a notch in the guide rail and a sensor in the holding device 24 that communicates to the controller which position the holding device 24 has reached as it moves outwardly from the segmented conveyor or other known positioning control means. The positioning control may move the holding device 24 along a respective guide rail 22 from the initial position to an exact position where the gripped container may be visually inspected, checked for leaks, etc and then moved to other positions for sorting. In an embodiment for visual inspection, etc., the segmented endless loop conveyor 19 may be arranged so that the gripped containers C are suspended from the conveyor above the ground so that the sides and bottoms of the container are accessible for visual inspection and other automatic checks on the container.

The holding device 24 remains in the desired position until the container C reaches a point where it is to be released. Generally, this is before the holding device 24 reaches starwheel 18. In the exemplary embodiment shown in FIGS. 1-3, the holding device 24 remains in the desired position until the containers C are in the delivery lane and its segment 20 of the segmented conveyor reaches starwheel 18. When the containers C are in the delivery lane, the containers C are removed from the gripper 26 of holding device 24. As shown in FIG. 2, when segment 20 reaches starwheel 18, gripper 26 releases container C and holding device 24 continues to move in the direction of transport T while container C is moved over the delivery lane in which it was positioned.

Alternatively, holding device 24 may release the containers C when they are positioned over a carton/packing case. In such an embodiment, the controller would move a line of containers C to a first position so that these containers line up with a carton and when released the container C are placed in the container and then a second line of containers C would be moved to a second position where the line up with the carton and are placed or released into the container, and so on. The carton may have a gate to allow a line of containers to be conveyed in, or the containers C may suspended above the carton and dropped in. If the containers C are suspended over a table, the cartons may be moved to a predetermined location under the line of containers and then the line of containers may be placed in the carton. If a cartons or packaging units with a gate are used, they may enter the path perpendicular to the line of conveying containers.

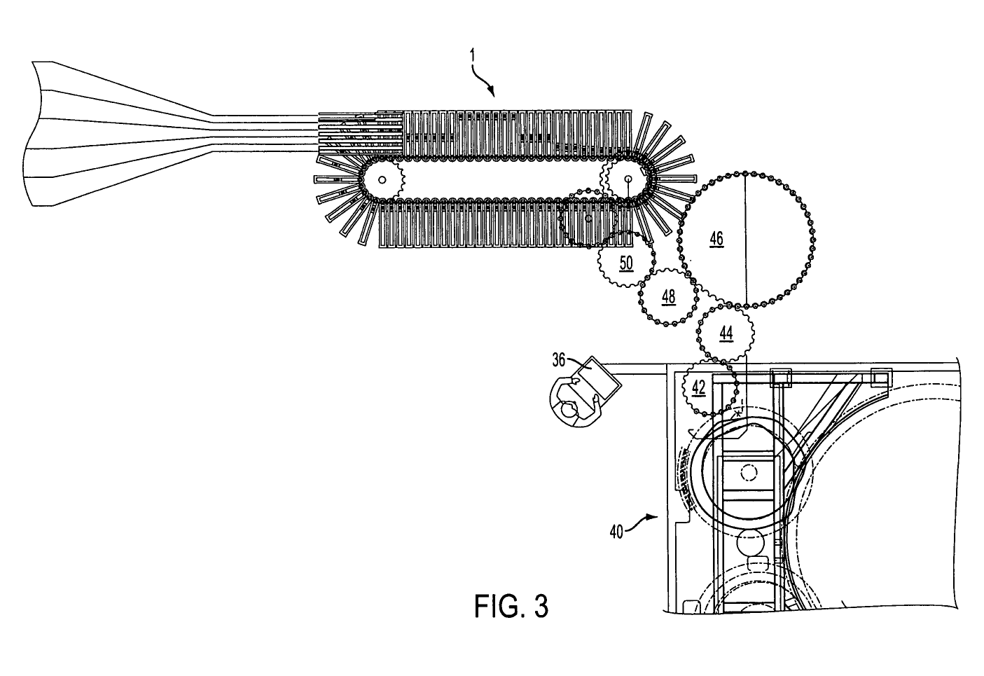

FIG. 3 illustrates the linking of an embodiment of apparatus 1 according to the invention with another container processing machine 40. In this exemplary embodiment, two starwheels 42, 44 take containers C from processing machine 40 in single file and then rotate around a larger diameter transition starwheel 46 and two additional starwheels 48, 50 before reaching the starwheel 10 of apparatus 1.

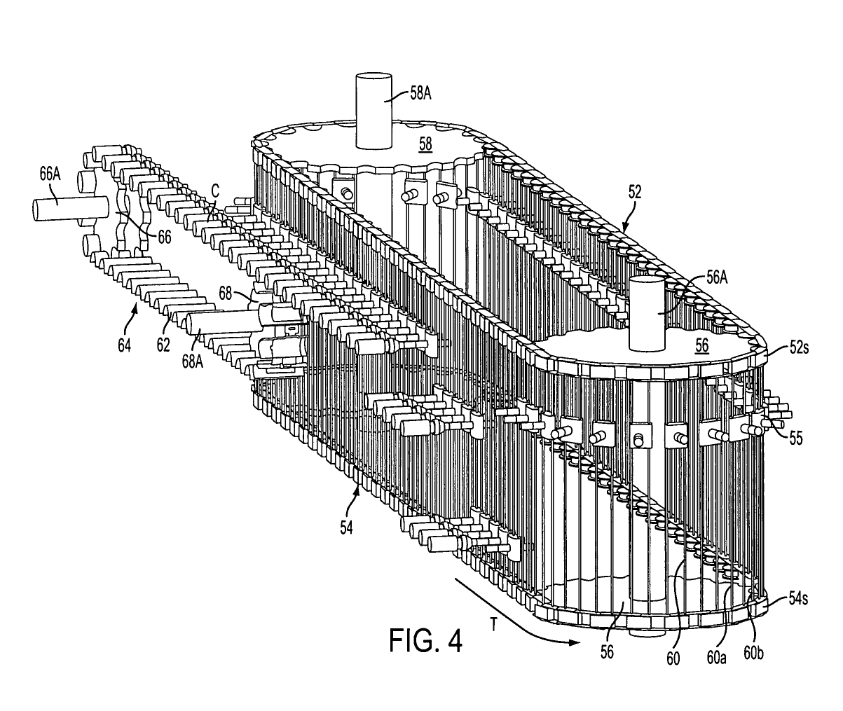

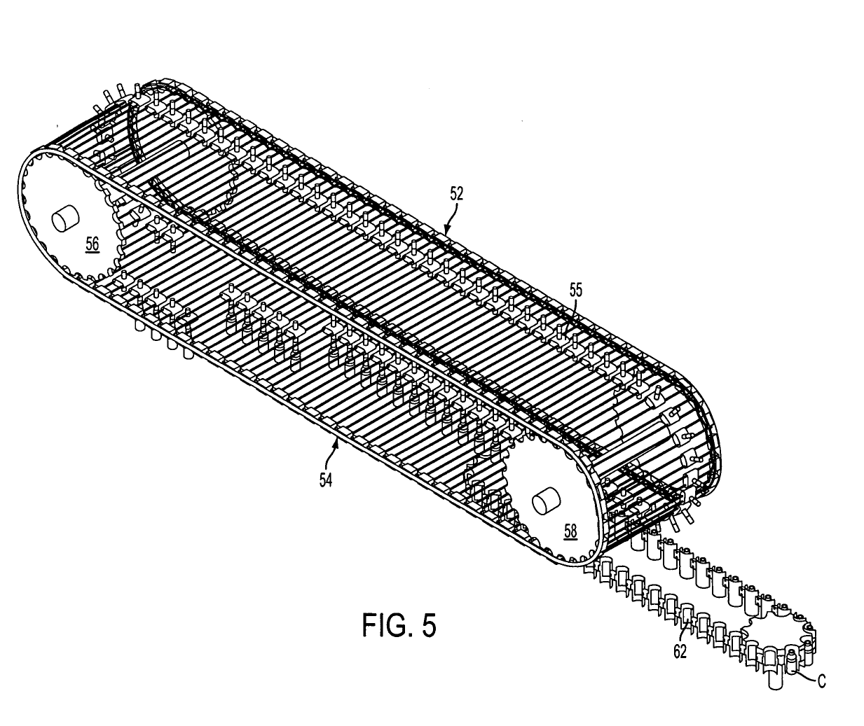

Another embodiment of the invention is illustrated in FIGS. 4 and 5. In this embodiment, the endless loop conveyor 19 includes a first segmented conveyor 52 and a second segmented conveyor 54 that are spaced from one another and move in the direction of transport T. At least two sets of rotary starwheels 56, 58 rotate about respective axes 56A, 58A. Each set of rotary starwheels 56, 58 has two starwheels spaced from one another along a spindle or respective axis (56A, 58A) where starwheels of one set 56 are in substantially the same plane as starwheels of the other set 58. Segmented conveyor 52 rotates about the one plane of starwheels 56, 58 and segmented conveyor 54 rotates about the other plane of starwheels 56, 58.

A guide rail 60 extends substantially perpendicular to the direction of transport T from a segment 52s of segmented conveyor 52 to a segment 54s of segmented conveyor 54. A holding device 55 is movably attached to the guide rail 60 so that it can move to varying positions between the two segmented conveyors 52, 54. The guide rail may include two rods 60a, 60b separated by a distance where the holding device 55 moves along these rods from an initial position near the first segmented conveyor to different positions moving toward the second segmented conveyor.

In the embodiment of FIGS. 4 and 5, the containers C are delivered in single file to an infeed station that can be, for example, a number of cradles 62 forming an endless loop conveyor 64. The endless loop conveyor 64 surrounds two starwheels 66, 68 that rotate about respective axes 66A, 68A. The rotation of starwheels 66, 68 and the set of starwheels 56, 58 are controlled so that the containers C are moved at substantially the same speed on both conveyors 52, 64. While axes 56A, 58A, as shown in FIGS. 4 and 5, are disposed perpendicular to the ground and axes 66A, 68A are substantially parallel to the ground, it is possible that in another embodiment the endless loop conveyor 64 and segmented conveyors 52, 54 may be disposed vertically with respect to the ground. In such an embodiment, containers C would be placed in a cradle 62 at starwheel 66 and then move along the conveyor 64. Similar to the embodiment shown in FIG. 2, containers C entering starwheel 68 would be gripped by holding devices 55 and then moved upward parallel to the segmented conveyors 52, 54 of endless loop conveyor 19.

In a vertical embodiment, axes 56A, 58A of the two sets of rotary starwheels 56, 58 about which the segmented conveyors rotate are substantially parallel with the ground and are perpendicular to axes 66A, 68A. The segmented conveyors endless loop 19 is positioned so that the containers C placed in cradles 62 move adjacent to holding devices 55 extending between the segmented conveyors 52, 54. The containers C gripped by holding devices 55 are held substantially perpendicular to the respective guide rail. The holding device 55 may include one of a gripper, suction cup, spindle or chuck to positively hold a container C while moving along the endless loop conveyor and a respective guide rail 60.

In the exemplary embodiment shown in FIGS. 4-5, the initial position of the holding device 55 corresponds with the neck of the container C placed in the cradle 62. A positioning control moves the holding device 55 along a respective guide rail 60 from the initial position to an exact position where the gripped container may be visually inspected, checked for leaks, etc and then moved to other positions for sorting. In that the segmented endless loop conveyor 19 is arranged substantially vertical to the ground and that the holding device 55 grips the containers C so that they extend outwardly or approximately perpendicular to the guide rail 60, the sides and bottoms of the container are accessible for visual inspection and other automatic checks on the container.

After visual inspection of a container is complete, the containers C can be moved to a final position for sorting. The vertical position of the segmented conveyors and guide rails allows machinery to check for leaks as well as visual inspection to occur while the containers C are moving along the endless loop conveyor 19. Once the gripped container C reaches a desired transition point, holding device 55 may release the container so that container C can move away from the apparatus 1 for positioning conveyed containers at different lengths from an initial position while the holding device 55 continues to move in the direction of transport T.

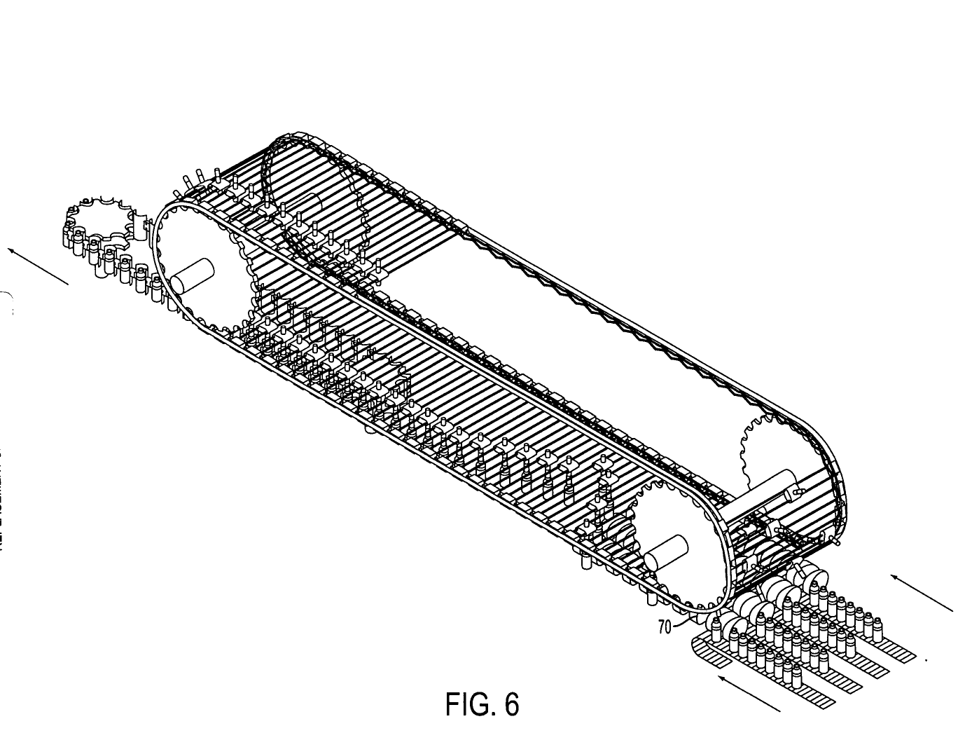

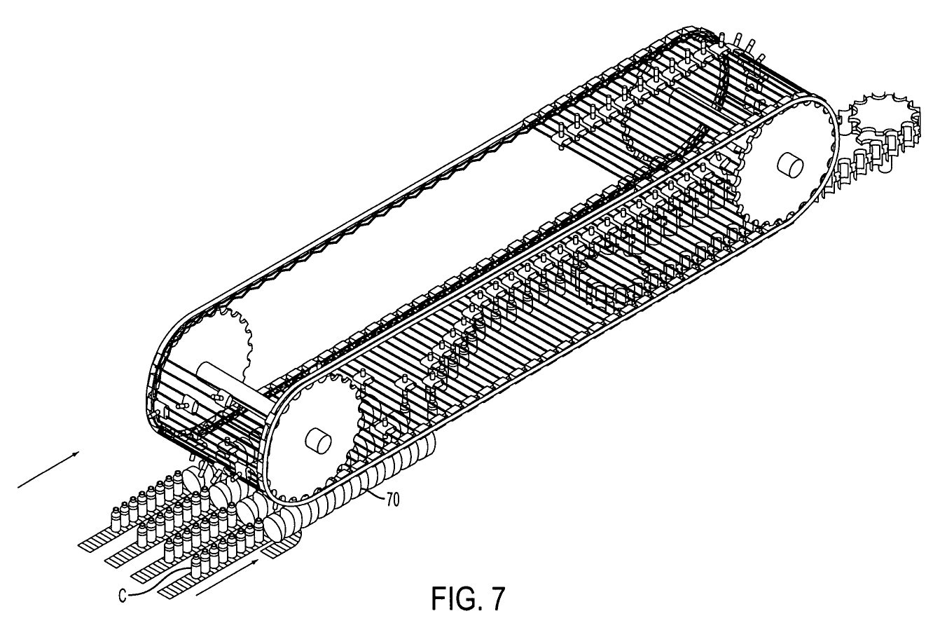

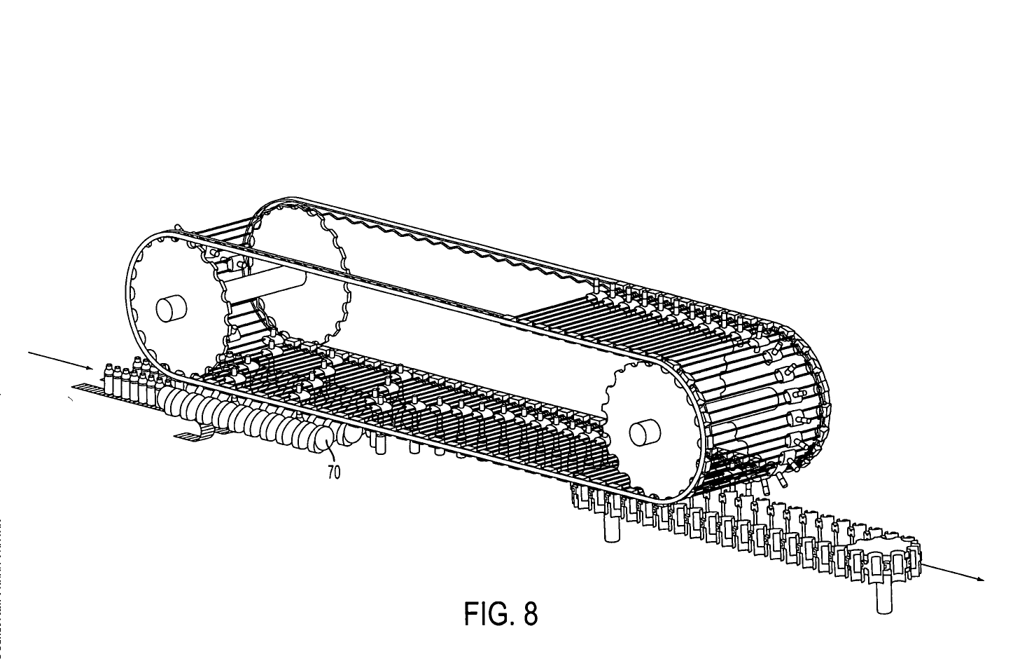

In another embodiment of the apparatus for positioning conveyed articles, the system as described above would run backwards. That is, as shown in FIGS. 6-8, a series of parallel streams of articles (containers C) are fed into the apparatus, which is a continuous motion combining device. Each parallel stream of articles is routed to a timing screw 70. In such a configuration, the majority of components and the configuration of the continuous motion diverting system would remain unchanged. However, a timing device, as described below, would be added and the conveyors would more in reverse.

The continuous motion combining device would receive a number of parallel streams of articles, such as multiple lanes (infeed lanes) of single file containers being conveyed and they would enter the device via a timing device that would separate the parallel streams of articles. For example, the conveyed streams of containers would terminate into star wheels, timing screws, or other appropriate device capable of creating a definite spacing of the articles. The timing devices would ensure that the articles to be combined arrive at a set spacing allowing for alternating feed from each of the infeed lanes. As shown in the FIGS. 6-8, the timing screws are designed so that each timing device feeds a container onto every fourth spindle of a holding device 55.

In such an arrangement, articles could be loaded onto all of the spindles of the holding devices 55 moving between first segmented conveyor 52 and second segmented conveyor 54. As the endless loop conveyor 19 is moved forward in the clockwise direction, the articles leave the control of the timing device (timing screws 70) and are gripped by the suction cup, spindle or chuck of holding device 55. Each holding device is moved to an initial position to a location corresponding to the infeed lane of the next container C to enter the endless loop conveyor 19. Then, as the endless loop conveyor 19 moves, the holding devices 55 are moved perpendicular to the direction of travel so that the gripped containers C are aligned in a single axis. The gripped containers C are received by a cradle 62 of a endless loop conveyor 64. At this point, the gripper of the holding device 55 is released and the containers C are moved into a single file out feed conveyance (arrow 74).

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. While the invention is described with respect to containers and a horizontal (containers move along a table) and a vertical orientation of endless conveyor systems, different orientations may be possible and still achieve continuous diverting of containers while moving continuously along a transport system. Similarly, any type of conveyable article may be used. That is, machine parts, candy, boxes/cartons and cases or anything that can be picked up with a gripper, suction cup or chuck may be employed as the article being conveyed and positioned. It is therefore to be understood that, within the scope of the claims and their equivalents, the invention may be practiced otherwise than as specifically described.

I claim:

1. An apparatus for positioning conveyed articles at different lengths from an initial position, said apparatus comprising:
an endless loop transport system that moves a number of containers in a direction of transport;
guide rails attached to the transport system and extending approximately perpendicular to the direction of transport;
a holding device movably disposed on a respective guide rail; and
a controller for moving the holding device perpendicular to the direction of transport along the respective guide rail where articles are gripped by a holding device while in continuous motion at an initial position and moved to different lengths along the guide rails.

2. The apparatus according to claim 1, further comprising a positioning control that moves the holding device along the guide rails to an exact position whereby the gripped article is moved to a desired transition point.

3. The apparatus according to claim 1, further comprising means of releasing the article from the holding device when the article has reached a desired location or transition point wherein the holding device continues to move in the direction of transport.

4. The apparatus according to claim 1, wherein the endless loop transport system includes at least two rotary starwheels spaced from one another and a segmented conveyor surrounding the at least two rotary starwheels.

5. The apparatus according to claim 4, wherein guide rails extend approximately perpendicular from each segment of the segmented conveyor and a holding device is movably disposed on each guide rail.

6. The apparatus according to claim 5, wherein each guide rail includes two rods separated by a distance and the holding device moves along those rods.

7. The apparatus according to claim 1, wherein the holding device includes one of a gripper, suction cup, spindle or chuck to positively hold a container while moving along the transport system and outwardly along the respective guide rail.

8. The apparatus according to claim 1, wherein the articles are containers and further comprising a device for aligning containers in single file, said device moving the containers in single file to an area of the transport system where a container is gripped by a respective holding device while moving in the direction of transport.

9. The apparatus according to claim 4, wherein the endless transport system moves the articles in a substantially horizontal plane with respect to the segmented conveyor.

10. The apparatus according to claim 1, wherein the articles are containers and the endless loop transport system includes first and second segmented conveyors spaced from one another and moving in the direction of transport, at least two sets of rotary starwheels spaced from one another along a spindle with the first and second segmented conveyors surrounding the at least two rotary starwheels.

11. The apparatus according to claim 10, wherein the guide rails extend from the first segmented conveyor to the second segmented conveyor.

12. The apparatus according to claim 11, further comprising a positioning control that moves the holding device along a respective guide rail from an initial position to an exact position where the gripped container may be visual inspected, checked for leaks and then moved to other positions for sorting.

13. The apparatus according to claim 11, further comprising means for releasing a gripped container from the holding device when the container is positioned at a desired transition point and the holding device continues to move in the direction of transport.

14. The apparatus according to 11, wherein the guide rails extend substantially perpendicular to the direction of transport and the gripped containers are held by the holding device substantially perpendicular to the respective guide rail.

15. The apparatus according to claim 14, wherein each guide rail includes two rods separated by a distance and the holding device moves along these rods from an initial position adjacent the first segmented conveyor to different positions closer to the second segmented conveyor.

16. The apparatus according to claim 10, wherein the holding device includes one of a gripper, suction cup, spindle, or chuck to positively hold a container while moving along the transport system and along the respective guide rail.

17. The apparatus according to claim 10, further comprising a device for presenting containers moving in single file adjacent to the holding device so that the containers can be gripped by the holding device while moving in the direction of transport.

18. The apparatus according to claim 10, wherein one set of starwheels and spindle is positioned above the other set of starwheels and spindle so that the transport system moves in a substantially vertical manner, and wherein the gripped containers extend outwardly from the respective guide rail so that the sides and bottom of the container can be visually checked.

19. A method for positioning conveyed articles at different lengths from an initial position, said method comprising:
transporting a number of articles in a single file to a holding device;
moving a transported article into an area to be gripped by a holding device in a direction of transport in an endless transport system;
moving the holding device and the gripped article along guide rails attached to the transport system in a direction approximately perpendicular to the direction of transport; and
controllably moving the holding device perpendicular to the direction of transport along the respective guide rail so that containers gripped by a holding device are moved while in continuous motion about the endless transport system from an initial position to different lengths along the guide rails.
